(19) United States
(12) Patent Application Publication
(10) Pub. No.: US 2013/0070382 A1
(43) Pub. Date: Mar. 21, 2013

(54) UNIVERSAL THERMAL MODULE WIRING CONNECTOR

(71) Applicants: Steve Fabian, Port Jefferson, NY (US); Thomas J. D'Agostino, Ronkonkoma, NY (US); Vulgens Schoen, Washington, NJ (US)

(72) Inventors: Steve Fabian, Port Jefferson, NY (US); Thomas J. D'Agostino, Ronkonkoma, NY (US); Vulgens Schoen, Washington, NJ (US)

(21) Appl. No.: 13/611,963

(22) Filed: Sep. 12, 2012

Related U.S. Application Data
(60) Provisional application No. 61/573,885, filed on Sep. 12, 2011.

(51) Int. Cl. H02H 5/04

(52) U.S. Cl. CPC H02H 5/04
USPC 361/103

(57) ABSTRACT

A universal thermal wiring connector is configured for monitoring ambient and conducted temperatures on all wire and wire terminal connections external to a wiring device, including supply leads and non-metallic outlet box to insure they are operating within an acceptable temperature range. The device is configured to terminate/disconnect the supply source, before the wiring device terminations, when an abnormal overheating temperature is detected. The device: prevents outlet box fires due to excessive overheating; can be incorporated external on standard receptacle or wiring devices; and provides a safer reasonable alternative with minimal added cost per unit. The device includes a wiring assembly consisting of UL listed wire, connectors, and a calibrated thermal fuse that is connected to the exterior screw terminal of a standard receptacle in the field by a licensed electrician or homeowner, or connected to the screw terminal of the receptacle when it is manufactured at the factory.

### CROSS REFERENCES TO RELATED APPLICATIONS

This application claims priority on U.S. Provisional Application Ser. No. 61/573,885 filed on Sep. 12, 2011, the disclosures of which are incorporated herein by reference.

### FIELD OF THE INVENTION

The present invention relates to improvements in the detection of abnormal temperature conditions in electrical receptacles or wiring devices, and more particularly to a device which is capable of preventing outlet box fires due to excessive overheating by monitoring conducted and ambient temperatures external to the device.

### BACKGROUND OF THE INVENTION

As is commonly known in the electrical wiring device industry over the last 40 years, a percentage of the receptacle outlet installations are done poorly, resulting in initial loose wiring, or arcing connections. These defects are not visible to a professional installer or consumer-homeowner, a condition that can result in a fire event if not corrected. An investigation performed by Underwriter Laboratories determined that poor workmanship does exist, and is now demonstrated in UL 1567, which addresses the concerns of torque, temperature, vibration, and installation.

When there is loose wiring or mechanically disturbed wiring terminal connections, which result in insulation faults, these conditions can initiate a failure mechanism process that causes abnormal overheating to increase temperature levels that can result in the ignition of the wiring materials in the receptacle outlet box, and/or the vicinity of the wall outlet box. Given the occurrence of poor workmanship, improper wiring at installation, and the normal use conditions including mechanical disturbances and vibrations, the outlet wiring may be subject to increased temperature conditions. In an electrical installation of a standard wiring device with a device of the present invention, such as a field wired or integral factory wired “Universal Thermal Module Wiring Connector,” the electrical power that feeds the wiring device will be interrupted, i.e., turned off, when the temperature in the outlet box becomes greater that the pre-determined set value of the thermal sensing device.

When detecting abnormal temperatures on the fixed wiring, or if the ambient temperature of the outlet or junction box exceeds the pre-determined temperature value, the outlet device or wiring which the Universal Thermal Module are connected directly will be turned off. The termination of the current will reduce the heat and prevent ignition of the wiring material, thermoplastic wire device box, the thermoplastic wire device cover plate, and/or the ignition of the wiring device in which it is connected. The present invention will also prevent metallic wiring device boxes from reaching an elevated temperature, which could allow insulation material surrounding the wire device boxes to ignite.

The present invention will prevent insulation or wiring material, which has been subjected to excessive temperatures, such as in attic spaces, which exceed the temperature limits of the insulating material from being turned on. Deformation of insulation wiring materials can result in arcing between metallic outlet boxes or between lines of different polarity.

Thermal protection exists in conventional wiring devices, however, due to the location of the thermal sensor these wiring devices do not protect the outlet box wiring. They protect only the wiring device, and not the thermoplastic outlet box, or cover plate, insulating material, nor the most important outlet wiring.

The Universal Thermal Module is very cost effective, and can be attached to any wiring device, external to the device itself. It is suitable for, but not limited to any standard receptacle, 15A or 20A, as well as switches, dimmers, GFCI, wiring devices. It is equally suitable for all appliance applications, such as personal computers, or main frames, as well as the protection of components and wiring devices inside the enclosure of an appliance, or electronic device.

### OBJECTS OF THE INVENTION

An object of the invention is to provide a connection to a standard receptacle or wiring device, which prevents a fire that may result from an undetected and on-going overheated wiring connection in an outlet box or a junction box.

Another object of the invention is to provide a Universal Thermal connection harness, which will connect to a standard receptacle or wiring device. The device of the present invention interrupts the source of electrical power before the wiring device, as opposed to at the terminals of the wiring device, when excessive overheating occurs in the receptacle wall outlet box or junction box. The device of the present invention may be connected to a standard receptacle or wiring device to stop progressive damaging effects of unwanted overheating at a loose binding head screw terminal, a wiring connection, a pressure plate screw terminal wiring connection, or a mechanically abused back-wire push-in (BWPI) terminal connection.

Another object of the invention is to provide a connection to a standard receptacle or wiring device, to stop progressive damaging effects of unwanted overheating at a loose binding head screw terminal wiring connection, a pressure plate screw terminal wiring connection, or a mechanically abused back-wire push-in (BWPI) terminal connection.

Another object of the invention is to provide a connector for connection to a standard receptacle or wiring device that interrupts and/or stops, the flow of electric current to the wiring device by activating a calibrated thermal sensor that may be integrated with the Universal Thermal Module Wiring Connector, at specified safe pre-ignition temperature.

Another object of the invention is to provide a connector for connection to a standard receptacle or wiring device that provides a reasonable alternate design that is safer and cost effective to manufacture, that reduces the risk of any future occurrence of a glowing connection that may arise as a result of an undetected progressive overheating condition at a wiring device connection.

Another object of the invention is to provide a means for monitoring the ambient temperature of the interior of a non-metallic outlet or junction box, and/or cover plate to ensure the temperature ratings of the non-metallic material of the box and cover are not exceeded.

Another object of the invention is to provide a means for monitoring the ambient temperature of the supply wiring in the interior of a non-metallic outlet or junction box, to ensure the temperature ratings of the wiring material are not exceeded.

Another object of the invention is to provide a means for monitoring high resistant connections that yield an abnormal temperature rise in the outlet or junction box.

Another object of the invention is to provide a means for monitoring damaged insulation wiring that yields an abnormal temperature rise, due possibly to arc tracking or bridging in the outlet or junction box.

Another object of the invention is to provide a means for monitoring damaged or abused standard receptacles or wiring devices that yield abnormal temperature rise in the outlet or junction box.

Another object of the invention is to facilitate installation of the device of the present invention so that by positioning the thermal sensor on an angle, it forces the installer to adequately and properly bend wires in outlet box, assuring a proper fold.

Another object of the invention is to provide a tamper resistant Binding Head Screw in an electrical connector that is used to assure that the Universal Thermal Module Wiring Device is permanently attached to the wiring device without altering the original wiring device assembly, and provides an exact pre-determined tightening value.

### SUMMARY OF THE INVENTION

The following is a broad outline of some of the features of the invention in order that the detailed description thereof may be better understood, and in order that the present contribution to the art may be better appreciated. There are additional features of the invention that will be described in more detail hereinafter.

In this respect, before explaining at least one of the embodiments of the invention in detail, it is to be understood that the invention is not limited in its application to the details of the construction or to the arrangement of the components set forth in the following description or illustrated in the drawings. The invention is capable of other embodiments and of being practiced and carried out in various ways. Also, it is to be understood that the phraseology and the terminology employed herein are for the purpose of the description and should not be regarded as limiting.

The present invention is directed to monitoring ambient and conducted temperatures on all wire and wire terminal connections of a wiring device including, but not limited to, supply leads and non-metallic outlet boxes. The present invention ensures that these components are operating within an acceptable temperature range, and is able to terminate or disconnect the supply source, before the wiring device overheats when an abnormal overheating temperature is detected. The present invention:
a) will prevent excessive overheating and fire that may occur in the outlet box;
b) can be incorporated on the external surface of a standard receptacle or any wiring device; and/or
c) provides a safer reasonable alternate device with only minor added cost per unit.

The present invention is unlike existing types of thermally protected wiring devices, which are incorporated internally to the device, and which cut off when the temperature of the device exceeds a given temperature. The Universal Thermal Module of the present invention is external to the device allowing it to be a permanent part of the wiring device through a tamper proof binding head screw, which makes it non-removable. By being external to the wiring device assembly, the thermal sensor monitors more than just the temperature of the wiring device. It can monitor the heat that is conductively transmitted from the wiring device, as well as radiated ambient heat within the junction/outlet box, protecting not only the wiring device, but also the fixed building wiring, as well as the thermoplastic junction box itself. Also, by monitoring the ambient temperature of the outlet box, it also ensures that a metallic box does not rise to a temperature that would adversely affect the surrounding wall insulation.

A primary feature of the present invention is a wiring assembly or harness that includes a supply wire, such as a UL listed wire, a thermal sensor, such as a calibrated thermal sensor, and one or more connectors. The assembly may be connected to the exterior screw terminal of a standard receptacle in the field by a licensed electrician or homeowner using a tamper proof binding head screw, or it may be connected to the screw terminal of the receptacle when it is manufactured at the factory.

The thermal sensor may be a suitable thermal sensing device that detects a pre-determined absolute temperature, and when activated, disconnects the supply lead to which it is attached. The sensor type may include, but not be limited to, a thermal fuse, PTC, Bimetal, or an electronic device.

A length of wire may connected to a wire connector on the device at one end, with the calibrated thermal sensor at the other end, and an insulated wire connects to the other end of the thermal sensor and is provided with a wire connector at its other end to facilitate field wiring. The connector facilitates connecting the feeder wire from the power source to the wiring device. The wire may be 14 AWG or 12 AWG, but is not limited to those sizes. The wire may be solid or stranded, and may preferably be rated above 70 degrees Celsius. The wire may be aluminum or copper.

The connector may be any field wiring type connector which is suitable for the application, according to gauge, temperature, and rating.

The binding head screw (BHS) is constructed using a tamper-proof head. Using a binding head screw with a tamper proof head assures that the Universal Thermal Module is permanently affixed to the wiring device it is incorporated into, and with its torque value being set by the factory.

The enclosure may be heat-shrinkable tubing, or may be formed of a thermoplastic material. Epoxy may be provided to seal terminations from air to prevent oxidation.

The Universal Thermal Module Connector can be fitted to any wiring device, such as a receptacle, a switch, a GFCI, a dimmer, etc. The Universal Thermal Module is preferably external to the device and secured by the taper resistant binding head screw.

The Universal Thermal Module wiring connector may be assembled integral with a standard duplex receptacle, and be installed in accordance with standard procedures of the National Electric Code.

### BRIEF DESCRIPTION OF THE DRAWINGS

FIG. 1 illustrates a first embodiment of the universal thermal wiring connector of the present invention.

FIG. 2 is an enlarged detail view of the thermal sensor of the universal thermal wiring connector of FIG. 1.

FIG. 3 is the enlarged detail view of FIG. 3, but illustrating a copper/aluminum wiring arrangement, with an aluminum lead supplying current to the thermal sensor, and with a copper lead supplying the current to the receptacle.

FIG. 4A is a perspective view of a second embodiment of the thermal wiring connector of the present invention, just prior to mating with a back-wire push-in type receptacle.

FIG. 4B is a perspective view of the second embodiment of the thermal wiring connector of FIG. 4A, but with mounting legs to augment the securing of the device to the receptacle.

FIG. 5A is a perspective view of the second embodiment of the thermal wiring connector of FIG. 4, after mating with the corresponding back-wire push-in type receptacle.

FIG. 5B is a perspective view of the second embodiment of the thermal wiring connector of FIG. 4B, after mating with the corresponding back-wire push-in type receptacle and also with use of the mounting legs.

FIG. 6 is a front view of the mated thermal wiring connector of FIG. 5B and the corresponding back-wire push-in type receptacle.

FIG. 7 is a side view of the mated thermal wiring connector of FIG. 5B and the corresponding back-wire push-in type receptacle.

FIG. 8 is a bottom view of the mated thermal wiring connector of FIG. 5B and the corresponding back-wire push-in type receptacle.

FIG. 9 is a front view of the thermal wiring connector of FIG. 4B.

FIG. 10 is a side view of the thermal wiring connector of FIG. 9.

FIG. 11 is a bottom view of the thermal wiring connector of FIG. 9.

FIG. 11A is an enlarged detail view of one of the legs and lip of the housing of the connector of FIG. 11.

FIG. 12 is an exploded view of the parts of the thermal wiring connector of FIG. 4B.

FIG. 13 is an exploded view of the parts of the back-wire push-in type receptacle of FIG. 4B.

FIG. 14 is a perspective view of a third embodiment of the thermal wiring connector of the present invention, just prior to mating with a back-wire push-in type receptacle.

FIG. 15 is a perspective view of the third embodiment of the thermal wiring connector of FIG. 14, after mating with the corresponding back-wire push-in type receptacle.

FIG. 16 is a front view of the mated thermal wiring connector of FIG. 15 and the corresponding back-wire push-in type receptacle.

FIG. 17 is a side view of the mated thermal wiring connector of FIG. 15 and the corresponding back-wire push-in type receptacle.

FIG. 18 is a bottom view of the mated thermal wiring connector of FIG. 15 and the corresponding back-wire push-in type receptacle.

FIG. 19 is a side view of the thermal wiring connector of FIG. 14.

FIG. 20 is a side view of the thermal wiring connector of FIG. 19.

FIG. 21 is a side view of the thermal wiring connector FIG. 20, but with the cover plate removed.

FIG. 22 is a bottom view of the thermal wiring connector of FIG. 19.

FIG. 23 is an exploded view of the parts of the thermal wiring connector of FIG. 14.

### DETAILED DESCRIPTION OF THE INVENTION

A primary feature of the present invention is a wiring assembly that includes a wire, such as a UL listed wire, one or more connectors, and a thermal sensor, such as a calibrated thermal sensor. The assembly may be connected to the exterior screw terminal of a standard receptacle in the field by a licensed electrician or homeowner, or connected to the screw terminal of the receptacle when it is manufactured at the factory.

The thermal sensor may be a suitable thermal sensing device that detects a pre-determined absolute temperature, and when activated, disconnects the supply lead to which it is attached. The sensor type may include, but not be limited to, a thermal fuse, PTC, Bimetal, or an electronic device.

A length of wire may be connected to a wire connector on the device at one end, with the calibrated thermal sensor at the other end, and an insulated wire connects to the other end of the thermal sensor and is provided with a wire connector at its other end to facilitate field wiring. The connector facilitates connecting the feeder wire from the power source to the wiring device.

The wire may be 14 AWG or 12 AWG, but is not limited to those sizes. The wire may be solid or stranded, and may preferably be rated above 70 degrees Celsius. The wire may be aluminum or copper.

The connector may be any field wiring type connector which is suitable for the application, according to gauge, temperature, and rating.

The binding head screw (BHS) is constructed using a tamper-proof head. Using a binding head screw with a tamper proof head assures that the Universal Thermal Connector is permanently affixed to the wiring device it is incorporated into, and with its torque value being set by the factory.

The enclosure may be heat-shrinkable tubing, or may be formed of a thermoplastic material. Epoxy may be provided to seal terminations from air to prevent oxidation.

The Universal Thermal Connector can be fitted to any wiring device, such as a receptacle, a switch, a GFCI, a dimmer, etc. The Universal Thermal Connector is preferably external to the device and secured by the taper resistant binding head screw.

The universal thermal wiring connector may be assembled integral with a standard duplex receptacle, and be installed in accordance with standard procedures of the National Electric Code.

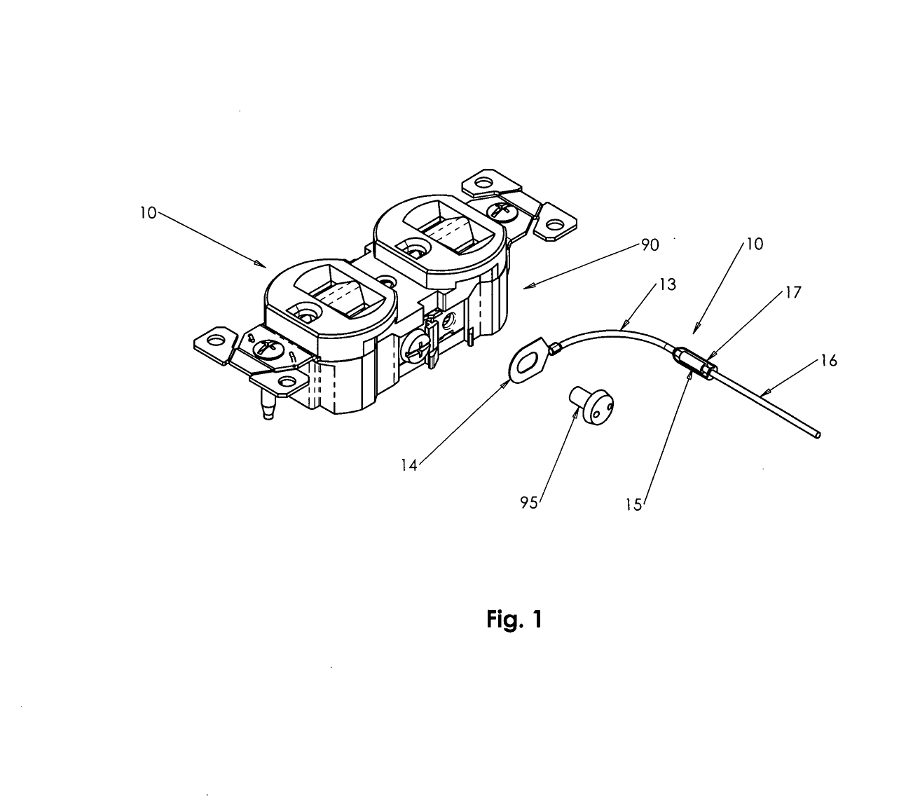

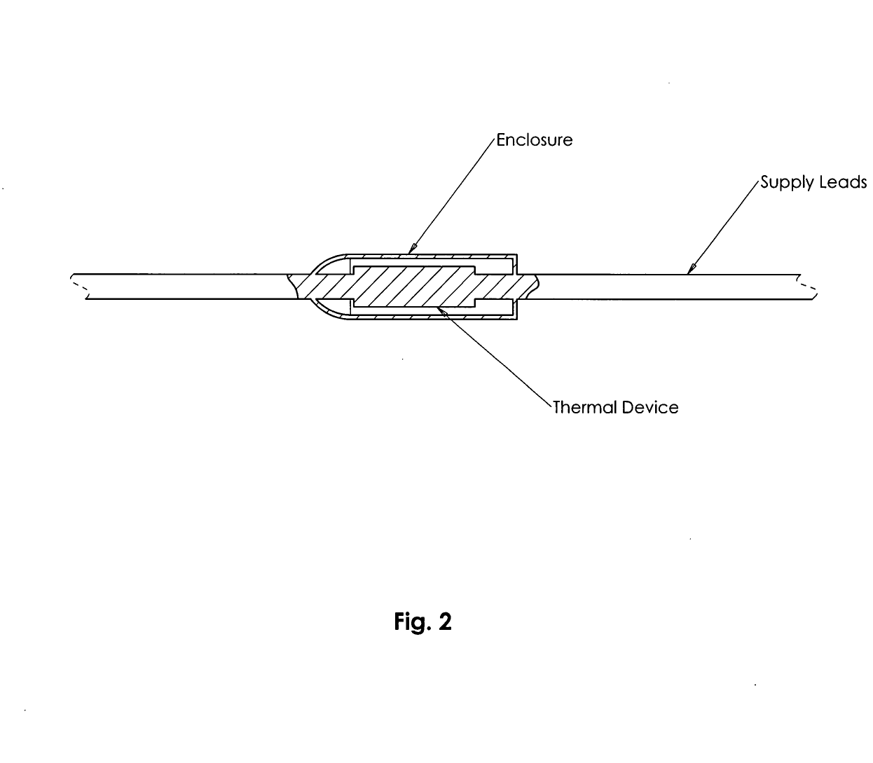

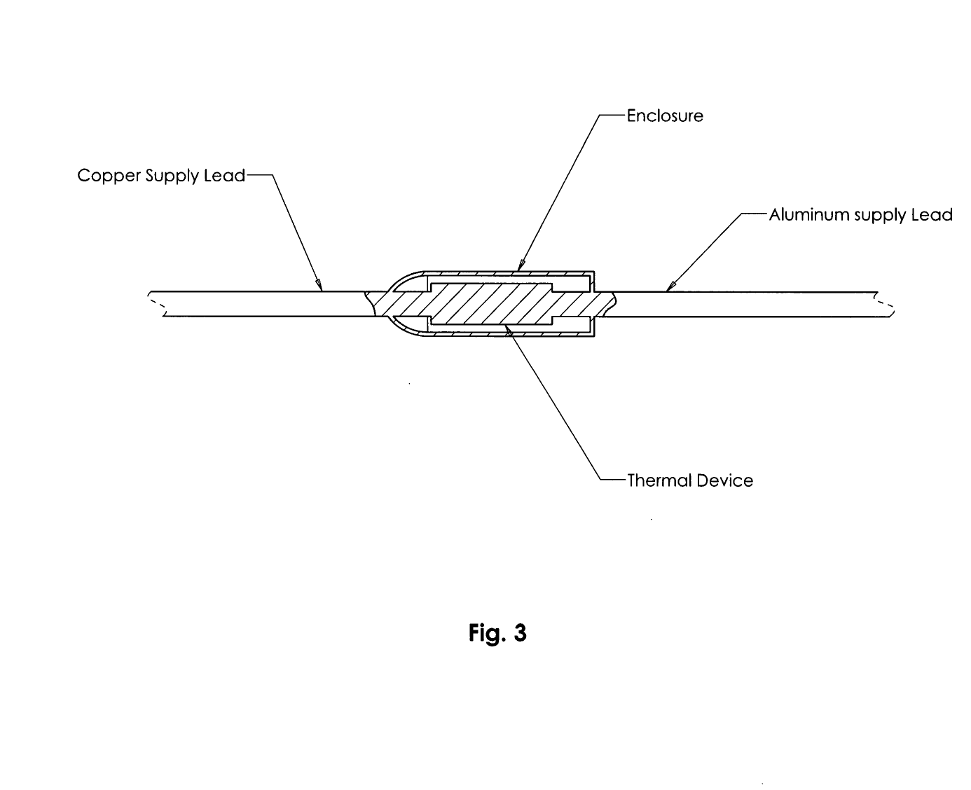

A first embodiment of the connector of the present invention is shown by the universal thermal wiring connector 10 of FIG. 1. The connector 10 may include supply lead wire 16 in series with a thermal sensor 15 that may be encased within enclosure 17, as described hereinabove. The thermal sensor may be in series on the downstream side with a second wire 13 that may terminate in a ring style wire end blade connector 14. The ring blade connector 14 may be secured to the terminal of the receptacle 90 using a binding head screw 12 that is constructed with a tamper-proof head. Although the tamper proof head of the binding head screw 12 in FIG. 1 is illustrated with the head having the double-hole arrangement for torquing that is commonly referred to as “snake eyes,” other tamper proof heads may also be used, such as those manufactured by the Tamperproof Screw Company of New York (see e.g., www.tamperproof.com/download-catalog.html). Thermal protection may preferably be provided on both the hot and neutral terminals using wiring connector 10.

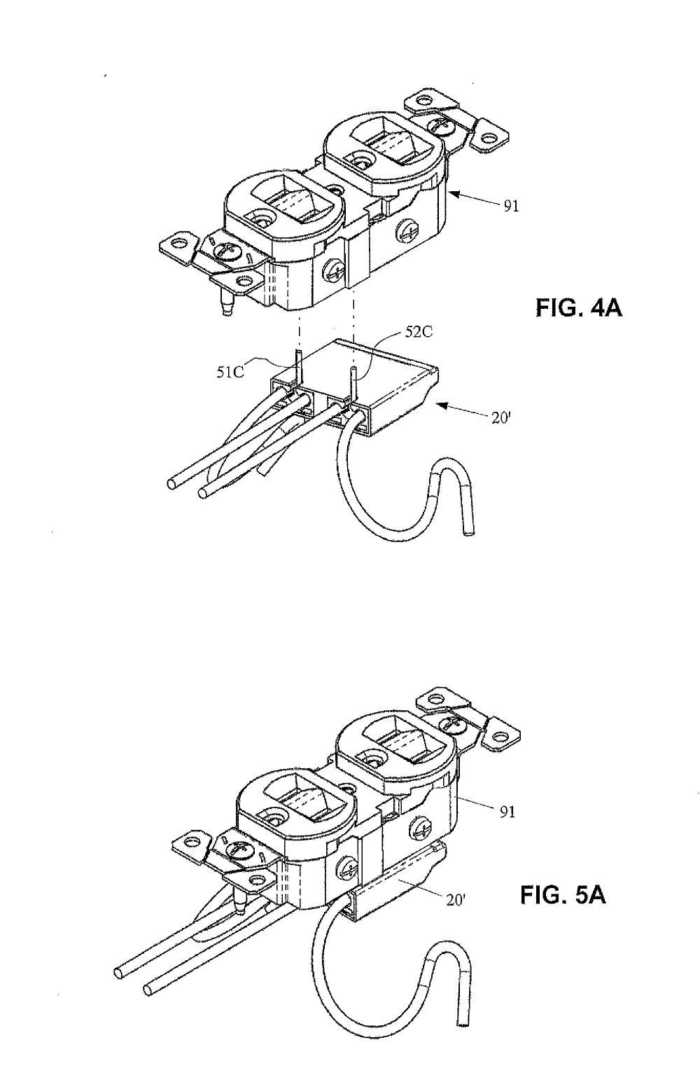

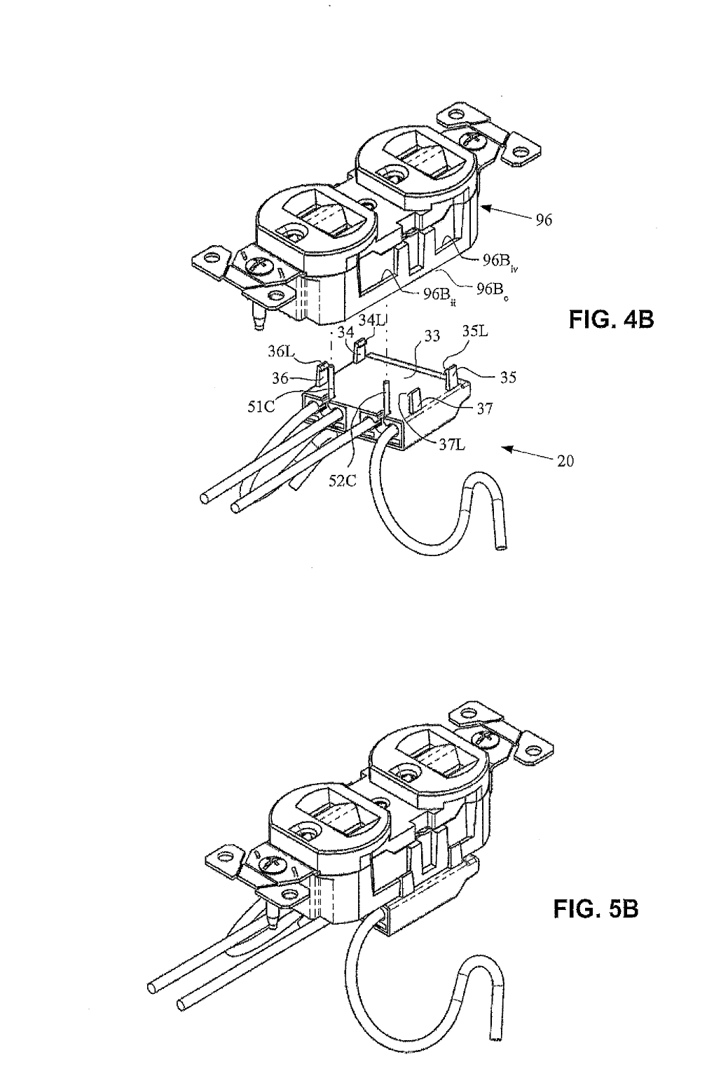

Two different versions of a second embodiment of the connector of the present invention are shown by the universal thermal wiring connector 20′ of FIG. 4A and the connector 20 of FIG. 4B. The connector 20′ is particularly adapted to being installed upon a receptacle having a pair of back-wire push-in receptacle terminal connections using only those terminal connections for mounting of the device, which may therefore be accomplished for any in-service BWPI receptacle. The connector 20 is particularly adapted to being mounted upon a corresponding receptacle 96 having a pair of back-wire push-in (BWPI) terminal connections, using both the terminal connections and a set of mounting legs that may be received by the receptacle, which serves to improve the reliability of the mounting, since the BWPI terminal connections of such receptacles do not consistently tend to retain the wire securely therein.

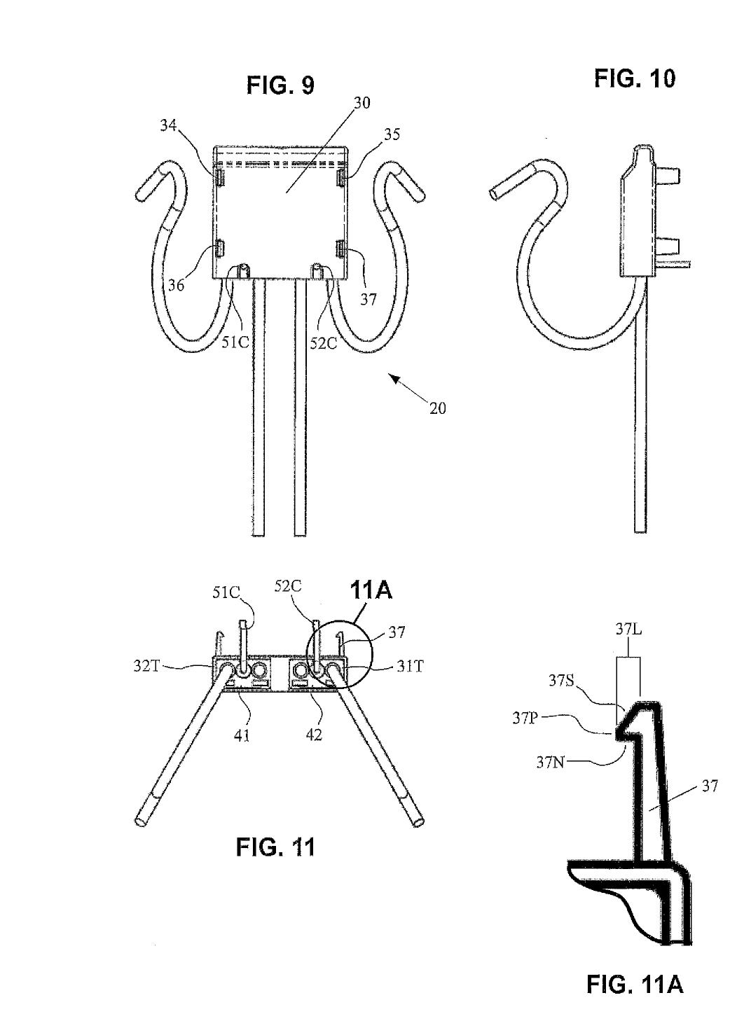

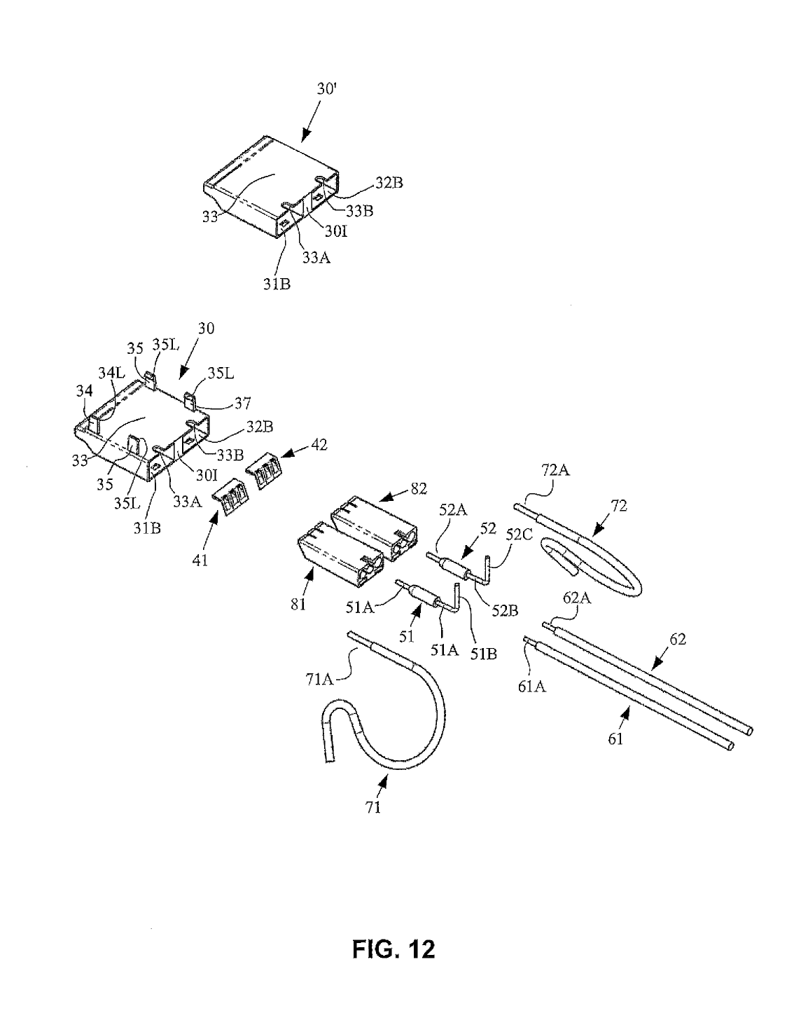

FIG. 4A shows a view with the connector 20 of the present invention being aligned with the corresponding receptacle 96, just prior to mounting of the device to the back-wire push-in receptacle, while FIG. 5B shows the device after being mounted to the receptacle. The device 20 is shown assembled in the views of FIGS. 9-11, and the component parts of connector 20 are shown in the exploded view of FIG. 12. The connector 20 may have a housing 30 that may have a plurality of wall sections that form a cavity. The plurality of wall sections may be integrally formed as a plastic injection molded part and may therefore be a single unitary wall that is multi-faceted. The cavity formed by the exterior wall sections may be partitioned using an interior wall 30W to form a first compartment 31 and a second compartment 32 that may respectively have a bottom opening 31B and 32B, as well as a top opening 31T and 32T.

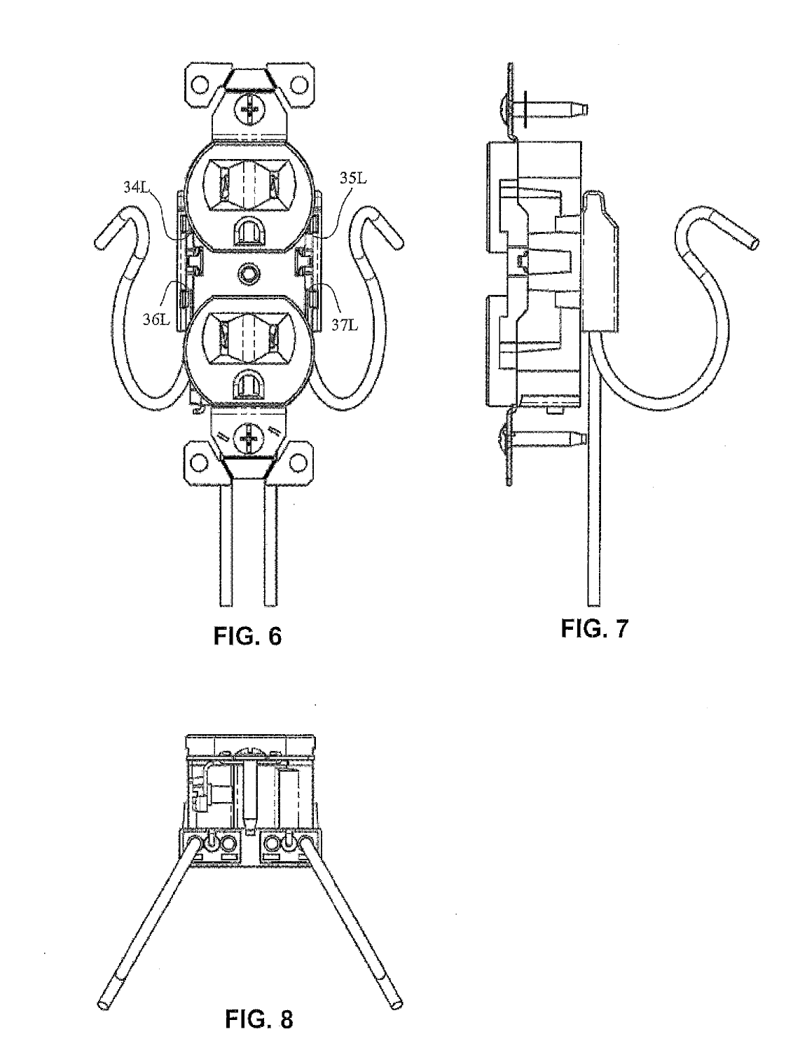

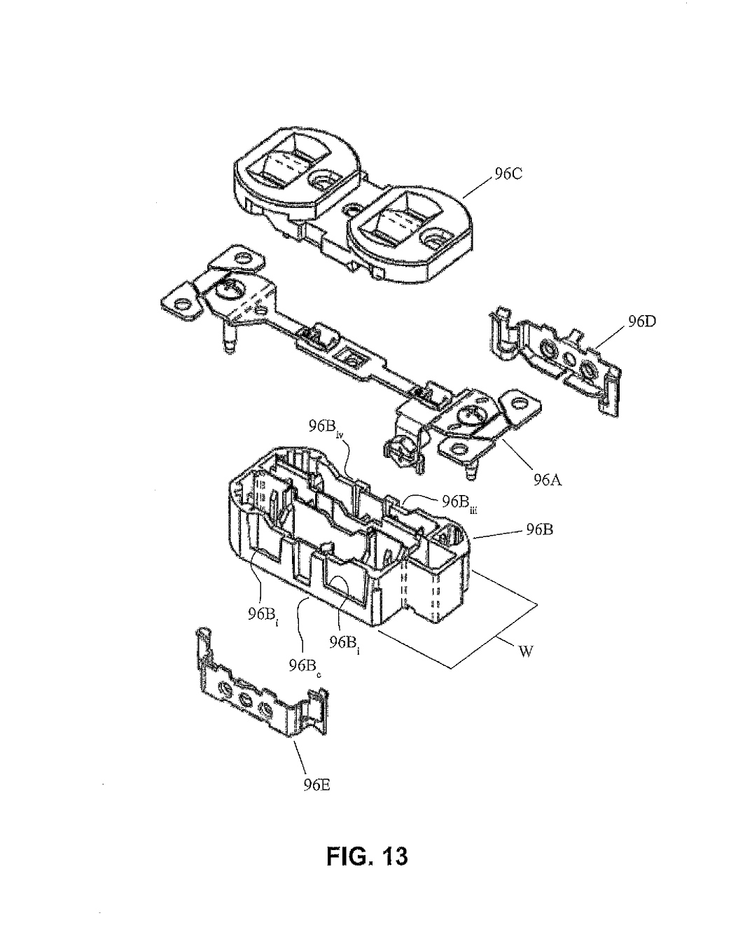

The back surface 34 of the housing 30 may be generally flat, and may have four flattened legs 34, 35, 36, and 37 that protrude orthogonally away from the surface, with the legs being located at the edge of the surface 34. The respective pairs of legs, 34/36 and 35/37 may be positioned at a distance away from each other that matches the width W (see FIG. 13) of the base of the receptacle 96, possibly being slightly larger so that the legs may straddle the base, as seen in FIG. 5. Each of the legs 34/36/35/37 may have a respective lip 34L/36L/35L/37L that may extend away from the legs to be usable for securing the device 20 to the receptacle, as seen in FIGS. 6-7. The lip 37L for leg 37 is shown in detail within FIG. 11A, and is representative for each of the legs. The lip 37L may be formed to have three or more discrete surfaces. A slanted surface 37S may be at an angle to the leg, being in the range of approximately 30 degrees to 60 degrees with the axial direction of the leg. The slanted surface 37S may transition into surface 37P being parallel to the axial direction of the leg. The transition may be a sharp corner, or it may be a radiused surface. The parallel surface 37P may end at a sharp corner with a surface 37N that may be normal to the axial direction of the leg. (Note—the housing 30′, which may be used in place of housing 30 for the assembly of connector 20′, is also illustrated in the exploded view of FIG. 12, and may be formed the same as housing 30, except that it does not have the legs 34/36/35/37, as noted above).

A first push connector 41 may be received into the first compartment to be fixedly secured to the housing 30 proximate to the top opening 31T. The first push connector 41 may contain 3 ports that are each usable for securing of and electrically coupling of a three respective wire leads therein. A second push connector 42 may similarly be received into the second compartment to be fixedly secured to the housing 30 proximate to the top opening 32T. The second push connector 42 may also contain 3 ports.

A first thermal sensor 51 may be received in the first compartment 31, with a first wire lead 51A of the sensor being inserted into a first port of the first push connector 41. The second wire lead 5113 of the thermal sensor 51 may make a 90 degree turn forming a portion 51C that may exit out the housing 30 through an opening 33A in the back surface 33 of the housing. A current supply wire 61, which may be insulated, may have a bare end 61A be inserted into a second port of the first push connector 41. A downstream current wire 71, which may be insulated, may have a bare end 71A be inserted into a third port of the first push connector 41.

Similarly, a second thermal sensor 52 may be received in the second compartment 32, with a first wire lead 52A of the sensor being inserted into a first port of the second push connector 42. The second wire lead 52B of the thermal sensor 52 may also make a 90 degree turn forming a portion 52C that may exit out the housing 30 through an opening 33B in the back surface 33 of the housing. A current supply wire 62, which may be insulated, may have a bare end 62A be inserted into a second port of the second push connector 42. A downstream current wire 72, which may be insulated, may have a bare end 72A be inserted into a third port of the second push connector 42.

In addition, the first thermal sensor 51, the current supply wire 61, and the downstream current wire 71 may each be pre-assembled into a mini-housing 81, which may have an interior shape, as seen in FIG. 12, which may be specifically formed to provide support for each of those members and to maintain separation therebetween. Pre-assembling of the first thermal sensor 51, the current supply wire 61, and the downstream current wire 71 into the mini-housing 81 also permits easier insertion of the respective leads of those members into the first push connector 41. The second thermal sensor 52, the current supply wire 62, and the downstream current wire 72 may similarly be pre-assembled into a mini-housing 82.

The assembled thermal wiring connector 20′, as seen in FIGS. 4A and 4B, may be secured to any back-wire push-in receptacle 91. Mounting of the thermal wiring connector 20′ to the standard back-wire push-in receptacle 91 may begin with alignment of the portion 51C of the second wire lead 51B of the thermal sensor 51, and alignment of the portion 52C of the second wire lead 52B of the thermal sensor 52, with the back wire openings of the receptacle 91, as seen in FIG. 4A. The thermal wiring connector 20′ may then be advanced toward the receptacle 91, with the wire lead portions 51C and 52C being received into the back wire openings of the receptacle, which thereby secure the connector 20′ with respect to the receptacle 91.

The assembled thermal wiring connector 20 may be secured to the corresponding receptacle 96 (FIGS. 4B and 5B), which may be comprised of the component parts illustrated in FIG. 13—a yoke 86A, a based 96B, a face 96C, a first contact 96D, and a second contact 96E. The base 96B of the receptacle may have a first pair of recesses 96Bi and 96Bii on a first side of the base, and a second pair of recesses 96Biii and 96Biv on a second side of the base for mounting of the connector thereon. (Note that the pair of recesses 96Bi and 96Bii on the first side of the base could be joined into a single recess, and also the pair of recesses 96Biii and 96Biv on the second side of the base may also be joined to form a single recess).

The piggyback mounting of the thermal wiring connector 20 with the back-wire push-in receptacle 96 may also begin with alignment of the portion 51C of the second wire lead 51B of the thermal sensor 51 and alignment of the portion 52C of the second wire lead 52B of the thermal sensor 52, with the back wire openings of the receptacle 96, as seen in FIG. 4. The thermal wiring connector 20 may then be advanced toward the receptacle 96, with the wire lead portions 51C and 52C being received into the back wire openings of the receptacle, and with the lips 34L/36L/35L/37L of the respective legs 34/36/35/37 contacting the sides of the base 96B of the receptacle. The first point on the legs to contact the base would be the slanted surfaces 34S/36S/35S/37S. Continued sliding movement of the thermal wiring connector 20 towards the receptacle 96 may then result in the engagement of the bottom corner of the base with the slanted surfaces of the legs, causing the legs to elastically deform outward. As the bottom corner of the base 96B_{C} of receptacle 96 approaches the back surface 33 of the housing 30, the corner between the parallel surfaces 34P/36P/35P/37P and the normal surfaces 34N/36N/35N/37N of the lip of the respective legs may traverse past the beginning of the recesses 96Bᵢ/96Bᵢᵢ/96Bᵢᵢᵢ/96Bᵢᵥ, permitting the legs to be restored elastically to their un-deformed position, where they straddle a portion of the base 96B of the receptacle 96, as seen in FIG. 5B.

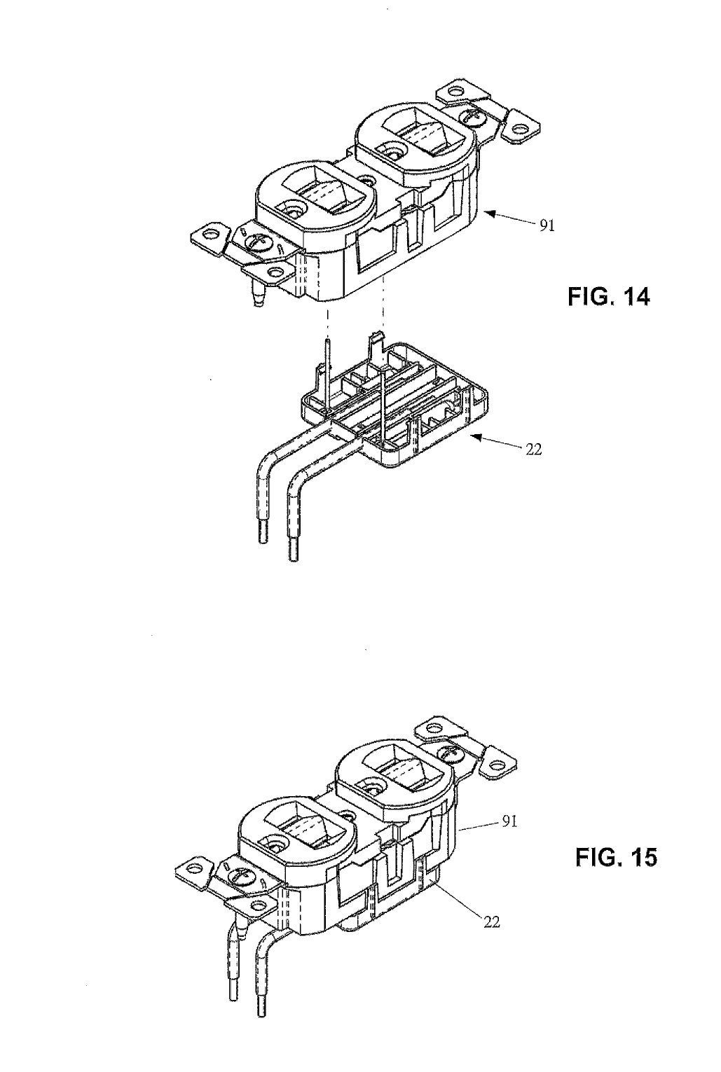

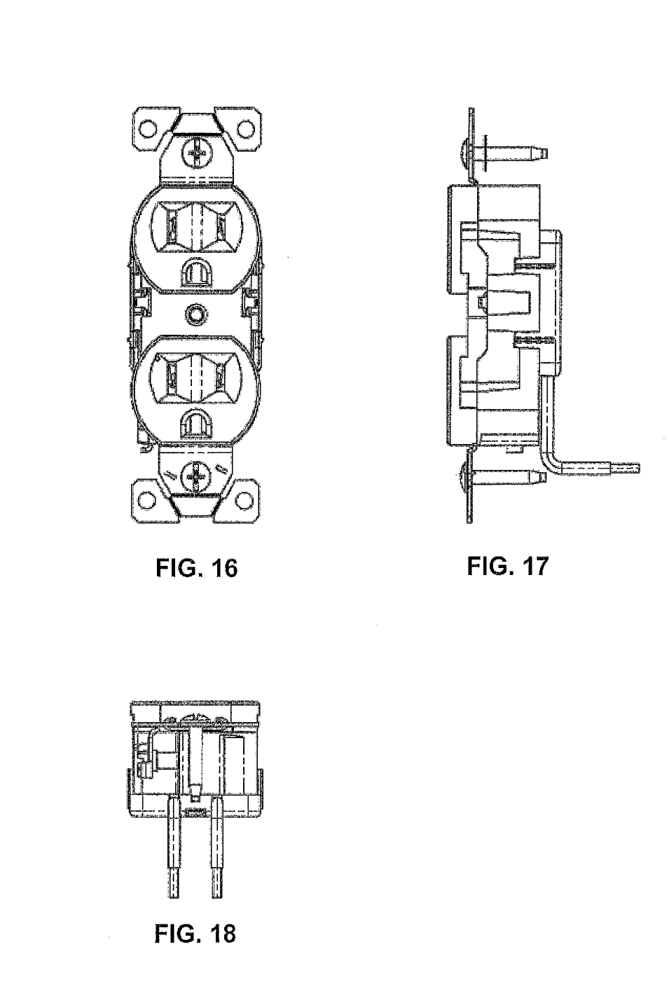

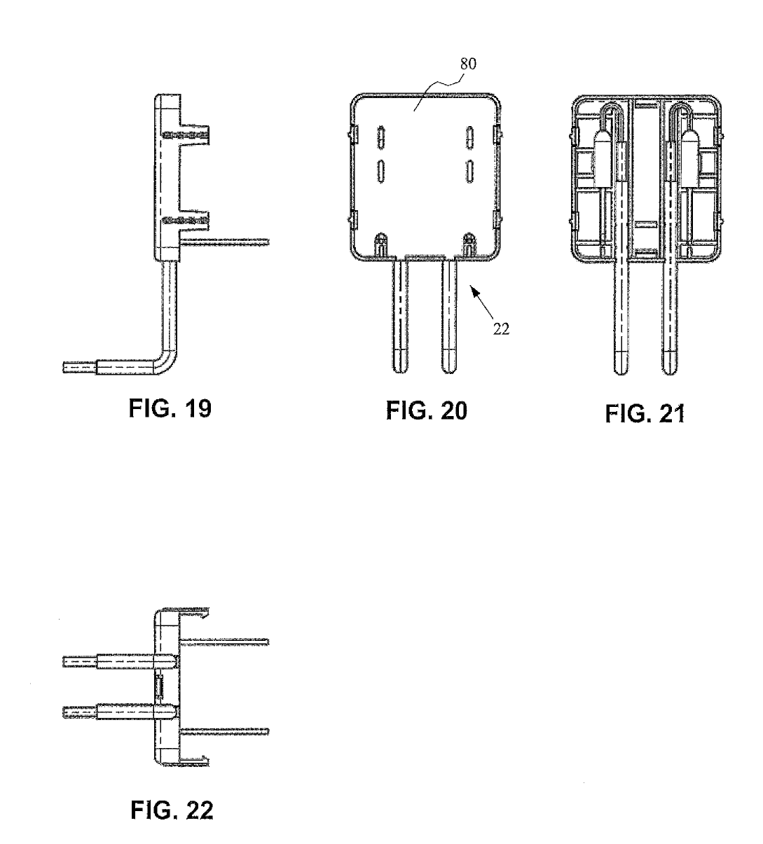

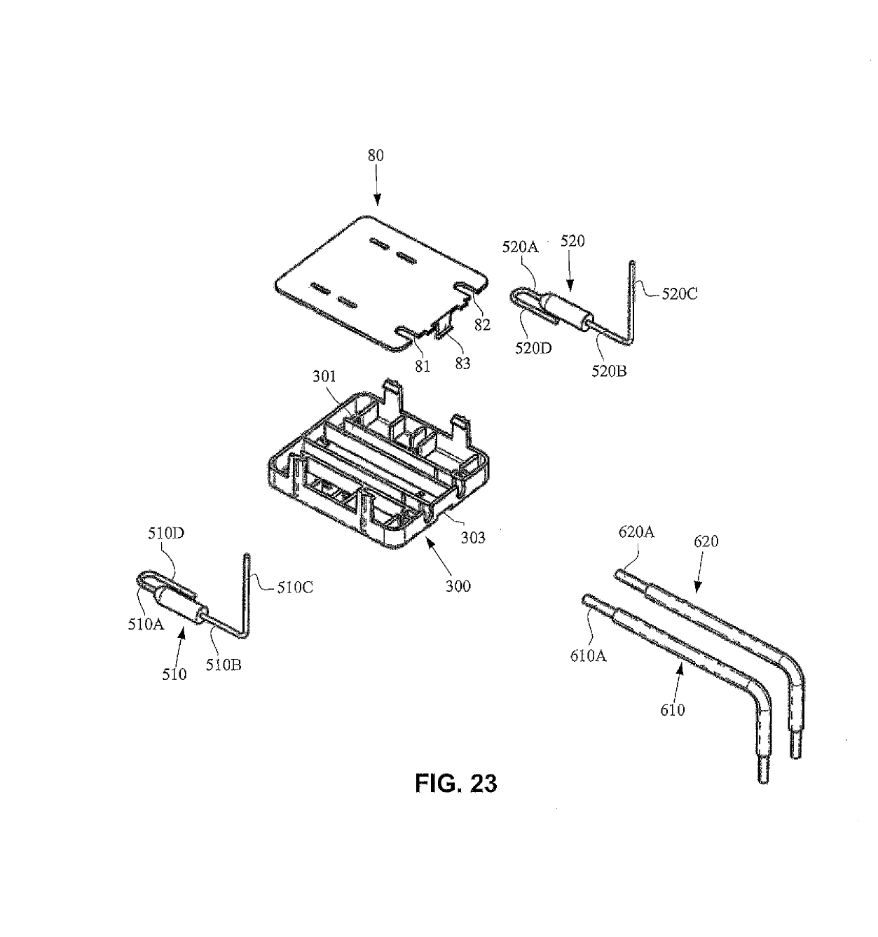

The thermal wiring connector 22, illustrated in FIGS. 14 through 23 may be similarly formed and attached to the receptacle, but may be constructed using an arrangement that eliminates the push connectors 41/42 of thermal wiring connector 20. As seen in FIG. 23, a housing 300 may be formed with feet and lips for attachment of the connector, similar to those on connector 20, but housing 300 may have a back opening for installation of the components therein, which may be sealed using a cover 80 that may snap into the housing tabs on the cover and openings in the housing, including tab 83 snapping into opening 303. The first thermal sensor 510 may be received within a mounting slot within the housing 300, with a first wire lead 510A looping around an interior wall 301 (see FIG. 21) to thereafter form a straight lead portion 510D. The second lead wire 510B of the first thermal sensor may make a 90 degree turn forming a portion 510C that may exit out the housing cover 80 through an opening 81 therein. The second thermal sensor 520 may also be received within a mounting slot within the housing 300, with a first wire lead 520A looping around an interior wall 302 to thereafter form a straight lead portion 520D. The second lead wire 520B of the second thermal sensor may make a 90 degree turn forming a portion 520C that may exit out the housing cover 80 through an opening 82 therein. A current supply wire 610, which may be insulated, may have a bare end 610A be electrically coupled, using a coupler, with the straight lead portion MOD of first thermal sensor 510. A second current supply wire 620, which may be insulated, may have a bare end 620A be electrically coupled, using a coupler, with the straight lead portion 520D of second thermal sensor 520.

The assembled thermal wiring connector 22, as seen in FIGS. 14 and 15, may be secured to any back-wire push-in receptacle 91. Mounting of the thermal wiring connector 22 to the standard back-wire push-in receptacle 91 may accomplished the same as described for the connector 20′.

The examples and descriptions provided merely illustrate a preferred embodiment of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

We claim:

1. An electrical wiring protection device, for use in monitoring radiated ambient temperatures of outlet boxes and conducted temperatures of wire and wire terminal connections of a wiring device, and for disconnecting the supply source when an abnormal overheating temperature is detected, said device comprising:
a first thermal sensor;
a second thermal sensor;
a first push connector;
a second push connector;
a housing, said first push connector and said second push connector being fixedly mounted within said housing in respective first and second compartments therein;
wherein said first sensor is received in said first compartment with a first lead of said first sensor being inserted into a first port of said first push connector, and an end portion of a second lead of said first sensor being bent at a 90 degree angle and exiting out an opening in a rear face of said housing; a first electrical current supply wire being received in a second port of said first push connector; an end of a downstream current wire being received in a third port of said first push connector; and
wherein said second sensor is received in said second compartment with a first lead of said second sensor being inserted into a first port of said second push connector, and an end portion of a second lead of said second sensor being bent at a 90 degree angle and exiting out an opening in said rear face of said housing; a second electrical current supply wire being received in a second port of said second push connector; an end of a downstream current neutral wire being received in a third port of said second push connector.

2. The electrical wiring protection device of claim 1 wherein said device is mounted to a back-wire push-in receptacle, with said second lead of said first sensor and said second lead of said second sensor being received in first and second back wire openings in the receptacle.

3. The electrical wiring protection device of claim 1 wherein said device is mounted to a back-wire push-in receptacle, with a respective lip on each of a first and second cantilevered leg of said housing being received in a pair of respective openings in a first side of the receptacle, and with a respective lip on each of a third and fourth cantilevered leg of said housing being received in a second pair of respective opening in a second side of the receptacle.

4. An electrical wiring protection device, for use in monitoring radiated ambient temperatures of outlet boxes and conducted temperatures of wire and wire terminal connections of a wiring device, and for disconnecting the supply source when an abnormal overheating temperature is detected, said device comprising: a thermal sensor having a first end being electrically coupled to a supply lead and a second end being electrically coupled to a first end of a length of wire, said thermal sensor and said electrical coupling at its first and second ends being enclosed in heat shrinkable tubing; a second end of said length of wire being electrically coupled to a blade connector.

5. The electrical wiring protection device of claim 4 wherein said device is mounted to a terminal of a receptacle, with said blade connector being secured to the terminal using a tamper proof binding head screw.

6. The electrical wiring protection device of claim 5 wherein said electrical coupling of said sensor to said supply lead and to said length of wire is sealed with epoxy.

7. An electrical wiring protection device, for use in monitoring a radiated ambient temperature of an outlet box and conducted temperatures of wire and wire terminal connections of a wiring device, and for disconnecting the supply source when an abnormal overheating temperature is detected, said device comprising:
a first thermal sensor;
a second thermal sensor;
a first push connector;
a second push connector;
a housing, said first push connector and said second push connector being received within said housing;
wherein said first sensor is received in said housing with a first lead of said first sensor being inserted into a first port of said first push connector, and an end portion of a second lead of said first sensor being bent at an angle and exiting out an opening in a rear face of said housing; a first electrical current supply wire being received in a second port of said first push connector; an end of a downstream current wire being received in a third port of said first push connector; and
wherein said second sensor is received in said housing with a first lead of said second sensor being inserted into a first port of said second push connector, and an end portion of a second lead of said second sensor being bent at an angle and exiting out an opening in said rear face of said housing; a second electrical current supply wire being received in a second port of said second push connector; an end of a downstream current wire being received in a third port of said second push connector.

8. The electrical wiring protection device according to claim 7 wherein said first push connector and said second push connector are fixedly mounted within said housing.

9. The electrical wiring protection device according to claim 8 wherein said housing has first and second compartments therein for receiving said first push connector and said second push connector respectively.

10. The electrical wiring protection device according to claim 9 wherein an end portion of a second lead of said first sensor is bent at an angle of 90 degrees.

11. The electrical wiring protection device according to claim 10 wherein an end portion of a second lead of said second sensor is bent at a 90 degree angle.

12. The electrical wiring protection device according to claim 11 further comprising a pair of mount legs extending outward from a periphery of said housing, each said leg of said pair of legs comprising a lip extending laterally therefrom, with said lip of each leg of said pair of legs being positioned to face each other.

13. The electrical wiring protection device according to claim 12 comprising a second pair of mounting legs extending outward from a periphery of said housing, each said leg of said second pair of legs comprising a lip extending laterally therefrom, with said lip of each leg of said second pair of legs being positioned to face each other.

14. The electrical wiring protection device according to claim 13, wherein said first pair of mounting legs extend from said housing at a first distance away from a first end of said housing, and said second pair of mounting legs extend from said housing at a second distance away from a second end of said housing, said first distance being approximately the same as said second distance.
